(19) United States
(12) Patent Application Publication
(10) Pub. No.: US 2013/0148715 A1
(43) Pub. Date: Jun. 13, 2013

(54) TELEVISION REMOTE CONTROL DEVICE, AND TELEVISION SYSTEM USING THE SAME

(71) Applicants: JIAN LI, Shenzhen City (CN); JIN-XIN WANG, Shenzhen City (CN); TANG LI, Shenzhen City (CN)

(72) Inventors: JIAN LI, Shenzhen City (CN); JIN-XIN WANG, Shenzhen City (CN); TANG LI, Shenzhen City (CN)

(73) Assignees: HON HAI PRECISION INDUSTRY CO., LTD., Tu-Cheng (TW); HONG FU JIN PRECISION INDUSTRY (SHENZHEN) CO., LTD., Shenzhen City (CN)

(21) Appl. No.: 13/525,558

(22) Filed: Jun. 18, 2012

(30) Foreign Application Priority Data
Dec. 9, 2011 (CN) 201110408592.7

(51) Int. Cl. H04N 11/02

(52) U.S. Cl. 375/240.01; 375/E07.026

(57) ABSTRACT

A television includes a program receiving unit, a display unit, a command receiving unit, a selection unit, a signal compressing unit, and a signal emitting unit. The program receiving unit receives a plurality of television program signals. The display unit displays program contents according to the television program signals. The command receiving unit receives a remote control signal. The remote control signal includes a display control command and a preview control command The selection unit selects the corresponding television programs to the display unit for being displayed in accordance with the display control command, and sends the corresponding television programs to the signal compression unit to be compressed in accordance with the preview control command. The signal emitting unit converts the compressed television signals into wireless radio signals and sends out the signals. The present disclosure further provides a television remote control device and a television system using thereof.

### BACKGROUND

1. Technical Field

The present disclosure relates to a remote control device, particularly to a remote control device for controlling television, and a television system using the television remote control device.

2. Description of Related Art

A User can change television programs shown by a television via a television remote control device. The television remote control device usually includes a plurality of buttons, and the television remote control device controls the television via operating the buttons. Because the television programs have become more abundant, user must switch between many channels to find the television program he wants to watch. Thus it may take a lot of time for the user to choose a particular desired television program for viewing. In addition, the television may be damaged due to switching channels too frequently.

Therefore, there is room for improvement in the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is a schematic diagram of an embodiment of a television system.

FIG. 2 is a block diagram of the television system shown in FIG. 1.

FIG. 3 is a flow chart of the television system shown in FIG. 1.

### DETAILED DESCRIPTION

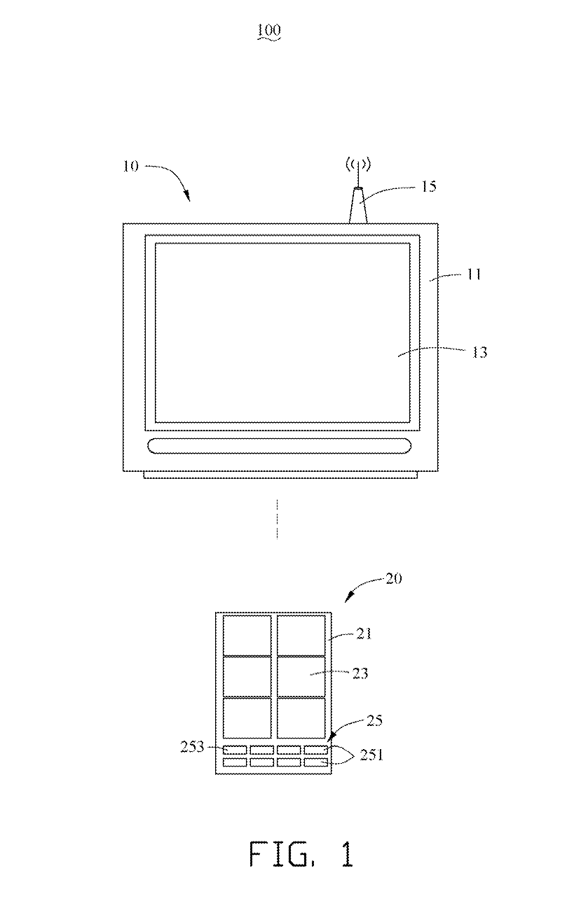

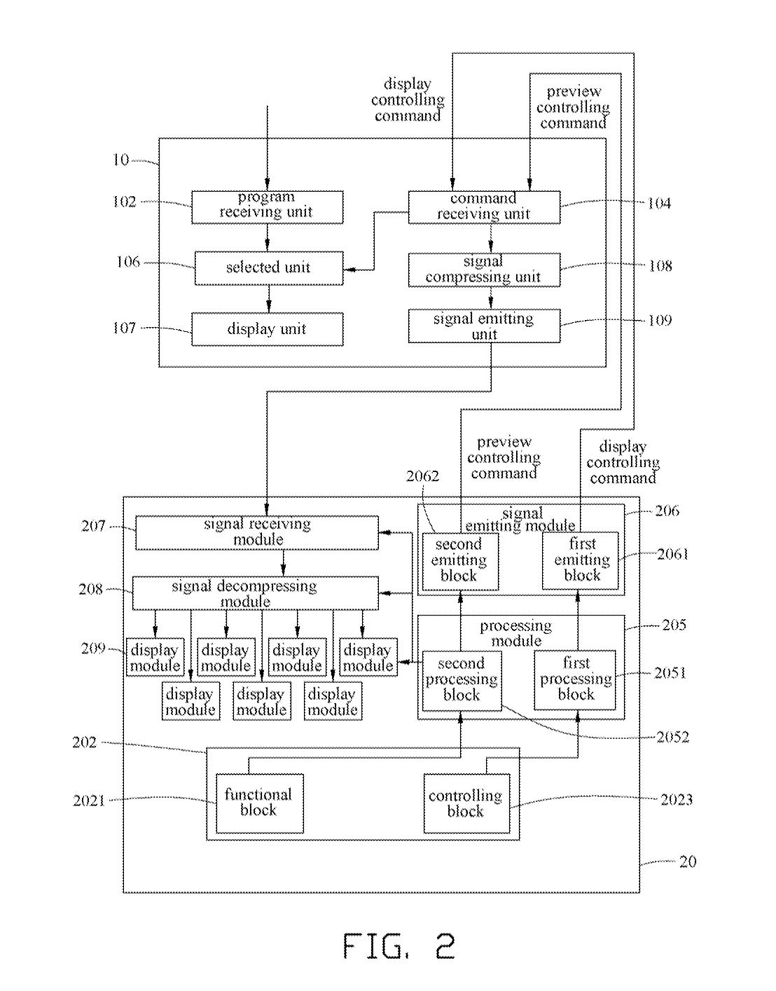

FIGS. 1 and 2, show an embodiment of a television system 100 including a television 10, a television remote control device 20 for the television 10. The television 10 includes a housing 11, a program receiving unit 102, a command receiving unit 104, a selection unit 106, a display unit 107, a signal compressing unit 108 and a signal emitting unit 109 received in the housing 11, a display 13 mounted on the housing 11, and a signal receiver 15 mounted on the top of the housing 11. The signal receiver 15 receives a plurality of television program signals and remote control signals emitted by the television remote control device 20 or other devices (not shown), and then the signal receiver 15 transmits the television program signals to the program receiving unit 102 and transmits the remote control signals to the command receiving unit 104. The display 13 displays the television program in a chosen television channel via the television remote control device 20. In other embodiment, the signal receiver 15 can be received in the housing 11.

The program receiving unit 102 receives the television program signals from the signal receiver 15. In the illustrated embodiment, the program receiving unit 102 receives a plurality of digitized television signals. The television program signals are a plurality of signals of different frequencies. In the illustrated embodiment, the program receiving unit 102 includes a plurality of receivers (not shown), allowing the program receiving unit 102 to receive and output a plurality of multi-frequency signals. In other embodiments, the program receiving unit 102 may be one receiver capable of receiving or outputting the multi-frequency signals.

The command receiving unit 104 receives the remote control signals emitted by the television remote control device 20. The remote control signals include a display control command and a preview control command The command receiving unit 104 controls the selection unit 106 to select a television program signal according to the received display control command, and controls the signal compressing unit 108 to compress the television program signals in accordance with the preview control command

The selection unit 106 selects a television program signal in accordance with the display control command, and transmits the selected television program signal to the display unit 107, and the display unit 107 displays the television channel program selected by the selection unit 106.

The signal compressing unit 108 compresses the television program signals according to the preview control command received by the command receiving unit 104, and transmits the compressed television program signals to the signal emitting unit 109. The signal emitting unit 109 converts the compressed television program signals to a plurality of radio signals, and emits or transmits the radio signals to the television remote control device 20.

The television remote control device 20 includes a housing 21, a battery (not shown), an operating module 202, a processing module 205, a signal emitting module 206, a signal receiving module 207, a signal decompressing module 208, and a plurality of display modules 209 received in the housing 21, a plurality of displays 23, and a plurality of buttons 25. The battery provides electrical power for the television remote control device 20. The displays 23 and the buttons 25 are mounted on a sidewall of the housing 21. The buttons 25 are used for selecting the television stations. The displays 23 can display the television programs in different channels according to the television program signals emitted by the television 10. The buttons 25 include a pair of page up-down buttons 251 and a preview button 253. In the illustrated embodiment, the battery is a lithium battery. There are six displays 23, and the displays 23 are a plurality of touch displays. The buttons 25 are touch buttons. In other embodiments, the battery can be a dry battery, the number of the displays 23 can be four or eight, for example. There are many buttons 25 configured to be used for providing setting adjustments, besides the page up-down buttons 251 and the preview button 253, for adjusting the volume, brightness, for example.

In the illustrated embodiment, there are six display modules 209 according to the six displays 23. The processing module 205 includes a first processing block 2051 and a second processing block 2052. The signal emitting module 206 includes a first emitting block 2061 and a second emitting block 2062. The first processing block 2051 and the second processing block 2052 can be integrated together, and the first emitting block 2061 and the second emitting block 2062 can be integrated together.

The operating module 202 responds to the operation of pressing the buttons 25, and controls the processing module 205 to process the depressing operation to transmit corresponding remote control commands The operating module 202 includes a functional block 2021 and a control block 2023. The functional block 2021 responses to the operation of depressing the preview button 253, and then controls the second processing block 2052 to process the operation of depressing the preview button 253 to actuate or transmit a preview control command Thus, the television remote control device 20 starts the program preview function. Meanwhile, the second processing block 2052 transmits the preview control command to the second emitting block 2062, and controls the signal receiving module 207, the signal decompressing module 208, and the display modules 209 to start. The second emitting block 2062 emits the preview control command

The control block 2023 responds to the touching operation of the display 23, and then controls the first processing block 2051 to process the touching operation of the display 23 to a display control command The first processing block 2051 transmits the display control command to the first emitting block 2061, and the first emitting block 2061 emits the display control command to the command receiving unit 104 of the television 10.

The signal receiving module 207 receives the compressed radio signals emitted by the television 10, and transmits the compressed radio signals to the signal decompressing module 208. The signal decompressing module 208 decompresses the compressed radio signals to a plurality of television program signals of different frequencies, and transmits the television program signals of having the different frequencies to the display modules 209. The display modules 209 preview the television programs in different channels. The number of the television channels is usually more than the number of the displays 23, thus the page up-down buttons 251 is provided to change to other television channels.

The television 10 of the television system 100 receives the preview control command emitted by the television remote control device 20, then compresses the television program signals, and converts the compressed television program signals to the radio signals to emit to the television remote control device 20. The television remote control device 20 decompresses the radio signals to a plurality of television program signals, and the display modules 209 display different television programs. Operators choose a desired television channel for viewing via touching the corresponding display 23, and the television remote control device 20 emits the display control command to the television 10 for controlling the television 10 to display the chosen channel for viewing.

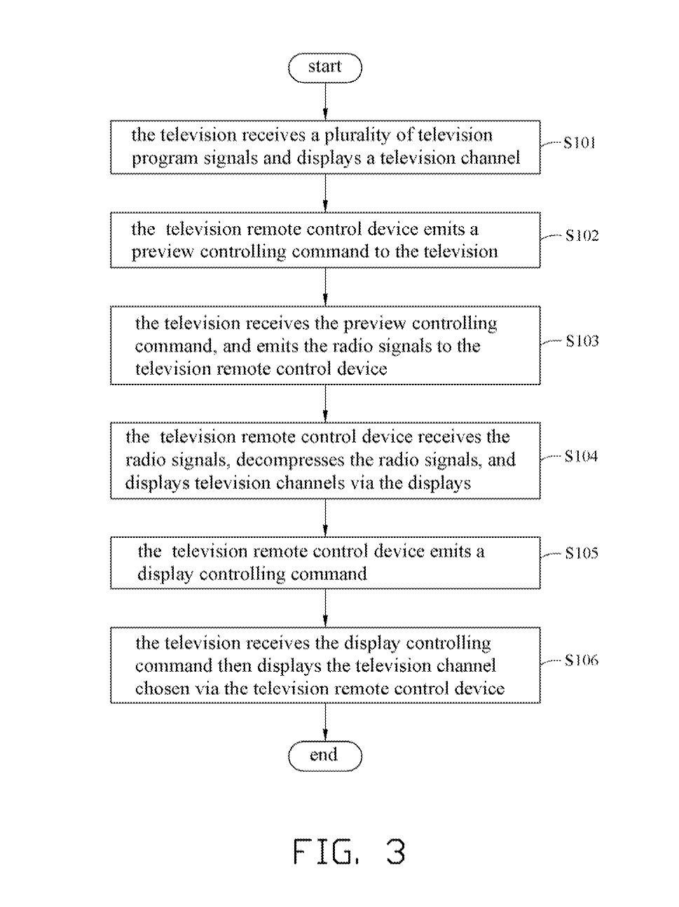

FIG. 3, is a television remote control method illustrated as follows.

In step S101, the television 10 is turned on by an operator or controlled by the television remote control device 20, and the television 10 then receives a plurality of television program signals and displays one television channel selected by the selection unit 106.

In step S102, the television remote control device 20 responds to the operation of an operator by depressing the preview button 253, and emits a preview control command to the television 10. In other words, the operator can require or control the television system 100 to preview television programs via depressing the preview button 253.

In step S103, the television 10 receives the preview control command, and then compresses the received television program signals, and converts the compressed television program signals to a plurality of radio signals to emit to the television remote control device 20.

In step S104, the television remote control device 20 receives the radio signals and decompresses the radio signals to a plurality of television program signals, and then the displays 23, display the television programs according to the television program signals.

In step S105, the television remote control device 20 responds to the operation of the operator by touching the selected display 23, and then emits a display control command to the command receiving unit 104 of the television 10.

In step S106, the television 10 receives the display control command emitted by the television remote control device 20, and then displays the television channel chosen via the television remote control device 20.

The television remote control device 20 has a plurality of touch displays 23, for previewing a plurality of television programs. The operator may choose any one of the television channels via touching one display 23 that is previewing the corresponding television program, and then the television remote control device 20 remotely controls the television 10 to display the chosen television channel. It is convenient for the operator to choose a television program via the television remote control device 20. In addition, the television 10 maintain to display the current television program until the operator decides which television program he wants.

It is believed that the present embodiments and their advantages will be understood from the foregoing description, and it will be apparent that various changes may be made thereto without departing from the spirit and scope of the embodiments or sacrificing all of its material advantages.

What is claimed is:

1. A television, comprising:
a housing; and
a program receiving unit received in the housing for receiving a plurality of television program signals;
a display unit received in the housing for displaying a television program according to the received television program signals;
a command receiving unit received in the housing for receiving a plurality of remote control signals, the remote control signals comprising a display control command and a preview control command;
a selection unit received in the housing for selecting one television program signal for the display unit according to the display control command;
a signal compressing unit received in the housing for compressing the television program signals; and
a signal emitting unit received in the housing for converting the compressed television program signals to a plurality of radio signals, and emitting the radio signals;
wherein when the command receiving unit receives the remote control signals, the command receiving unit controls the signal compressing unit to compress the television program signals, and then the signal emitting unit converts the compressed television program signals to the radio signals and emits the radio signals.

2. The television of claim 1, wherein the program receiving unit comprises one or more receivers capable of receiving and outputting a plurality of multi-frequency signals, to make the program receiving unit to receive and output the multi-frequency signals.

3. The television of claim 1, wherein the program receiving unit receives a plurality of digitized television signals.

4. The television of claim 1, wherein further comprises a display mounted on the housing, the display displays a television program in a television channel.

5. The television of claim 1, wherein further comprises a signal receiver mounted on the housing, the signal receiver receives the television program signals or the remote control signals emitted by other devices.

6. The television of claim 5, wherein the signal receiver transmits the television program signals to the program receiving unit and transmits the remote control signals to the command receiving unit.

7. A television remote control device, comprising:
a housing;
a plurality of displays mounted on a sidewall of the housing;
a plurality of buttons mounted on the sidewall of the housing adjacent to the displays;
an operating module received in the housing for responding to the operation of pressing the button;
a processing module received in the housing for processing the operation of pressing the button to a plurality of remote control signals, and transmitting the remote control signals;
a signal emitting module received in the housing for emitting the remote control signals;
a signal receiving module received in the housing for receiving a plurality of compressed radio signals;
a signal decompressing module received in the housing for decompressing the compressed radio signals;
wherein when the operating module responds to the operation of pressing the button by an operator, and then the operating module controls the processing module to process the operation of pressing the button to actuate corresponding remote control signals; the processing module transmits the remote control signals to the signal emitting module; the signal emitting module emits the remote control signals; the signal receiving module receives the compressed radio signals; the signal decompressing module decompresses the compressed radio signals to a plurality of television program signals, and the plurality of displays display the television programs in different television channels.

8. The television remote control device of claim 7, wherein the plurality of buttons comprises a preview button; the plurality of displays are a plurality of touch displays; the remote control signals comprises a display control command and a preview control command; the operating module comprises a functional block and a control block; the functional block responds to the operation of depressing the preview button by an operator, and then the functional block controls the processing module to process the operation of depressing the preview button to transmit the preview control command; the control block responds to the operation of touching the display by an operator, thereby controlling the processing module to process the operation of touching the display to transmit the display control command

9. The television remote control device of claim 8, wherein the processing module comprises a first processing block and a second processing block; the first processing block processes the operation of touching the display to transmit the display control command; the second processing block processes the operation of depressing the preview button to transmit the preview control command.

10. The television remote control device of claim 9, wherein the second processing block controls the signal receiving module, the signal decompressing module, and the display modules to start.

11. The television remote control device of claim 9, wherein the signal emitting module comprises a first emitting block and a second emitting block; the first processing block transmit the display control command to the first emitting block, and the first emitting block emits the display control command; the second processing block transmit the preview control command to the second emitting block, and the second emitting block emits the preview control command

12. A television system, comprising:
a television and a television remote control device;
the television, comprising:
a housing; and
a program receiving unit received in the housing for receiving a plurality of television program signals;
a display unit received in the housing for displaying a television program according to the received television program signals;
a command receiving unit received in the housing for receiving a plurality of remote control signals, the remote control signals comprising a display control command and a preview control command;
a selection unit received in the housing for selecting one television program signal for the display unit according to the display control command;
a signal compressing unit received in the housing for compressing the television program signals; and
a signal emitting unit received in the housing for converting the compressed television program signals to a plurality of radio signals, and emitting the radio signals;
the television remote control device, comprising:
a housing;
a plurality of displays mounted on a sidewall of the housing;
a plurality of buttons mounted on the sidewall of the housing adjacent to the displays;
an operating module received in the housing for responding to the operation of pressing the button;
a processing module received in the housing for processing the operation of pressing the button to generate a plurality of remote control signals, and transmitting the remote control signals;
a signal emitting module received in the housing for emitting the remote control signals;
a signal receiving module received in the housing for receiving the compressed radio signals;
a signal decompressing module received in the housing for decompressing the compressed radio signals;
wherein the signal emitting module emits the remote control signals; the remote control signals comprises a display control command and a preview control command; the command receiving unit of the television receives the remote control signals; the selection unit selects a program to display in the display unit according to the display control command; the signal compressing unit compresses a plurality of television program signals according to the preview control command, and transmits the compressed television program signals to the signal emitting unit; the signal emitting unit converts the compressed television program signals to a plurality of radio signals, and emits the radio signals; the signal receiving module of the television remote control device receives the compressed radio signals; the signal decompressing module decompresses the compressed radio signals to a plurality of television program signals, and then the signal decompressing module transmits the television program signals to the display modules to display the television programs in different channels.

13. The television system of claim 12, wherein the plurality of buttons comprises a preview button; the plurality of displays are a plurality of touch displays; the operating module comprises a functional block and a control block; the functional block responds to the operation of an operator pressing the preview button, and then the functional block controls the processing module to process the operation of pressing the preview button to emit the preview control command; the control block responds to the operation of an operator touching the display, thereby controlling the first processing block to process the operation of touching the display to the display control command

14. The television system of claim 13, wherein the processing module comprises a first processing block and a second processing block; the first processing block processes the operation of touching the display to transmit the display control command; the second processing block processes the operation of depressing the preview button to transmit the preview control command

15. The television remote control device of claim 14, wherein the second processing block controls the signal receiving module, the signal decompressing module, and the display modules to start.

16. The television remote control device of claim 14, wherein the signal emitting module comprises a first emitting block and a second emitting block; the first processing block transmits the display control command to the first emitting block, and the first emitting block emits the display control command; the second processing block transmit the preview control command to the second emitting block, and the second emitting block emits the preview control command

17. The television of claim 12, wherein further comprises a signal receiver mounted on the housing, the signal receiver receives the television program signals or the remote control signals emitted by other devices.

18. The television of claim 17, wherein the signal receiver transmits the television program signals to the program receiving unit and transmits the remote control signals to the command receiving unit.
